(19) United States
(12) Patent Application Publication
(10) Pub. No.: US 2024/0220644 A1
(43) Pub. Date: Jul. 4, 2024

(54) DATA DISTRIBUTION METHOD, FIRST TERMINAL EQUIPMENT, SECOND TERMINAL EQUIPMENT, DATA DISTRIBUTION SYSTEM, AND NON-TRANSITORY RECORDING MEDIUM

(71) Applicant: NEC Corporation, Minato-ku, Tokyo (JP)

(72) Inventor: Shinichi AMANO, Tokyo (JP)

(73) Assignee: NEC Corporation, Minato-ku, Tokyo (JP)

(21) Appl. No.: 18/555,152

(22) PCT Filed: Apr. 22, 2021
(86) PCT No.: PCT/JP2021/016268

§ 371 Date: Oct. 12, 2023

(51) Int. Cl. G06F 21/62; G06F 21/60

(52) U.S. Cl. CPC G06F 21/62; G06F 21/604

(57) ABSTRACT

In order for data to be easily and securely distributed, a data distribution method includes: causing (S1) first terminal equipment (1) of an owner to acquire a data item requested by a consumer; generating (S2), in a case where the owner has permitted disclosure of data, disclosure permission information which means that the owner has permitted disclosure of the data to the consumer and which is unique in a management apparatus (3) managing the data; storing (S3) the disclosure permission information in storage (4) capable of being read by the management apparatus (3), with the disclosure permission information being associated with the data item; outputting (S4), from the first terminal equipment (1), the disclosure permission information and access information for access to the management apparatus so that second terminal equipment (2) of the consumer can acquire the disclosure permission information and the access information directly from the first terminal equipment (1); sending (S5) the disclosure permission information from the second terminal equipment (2) to the management apparatus (3); and returning (S6), from the management apparatus (3) to the second terminal equipment (2), the data concerning the data item associated with the disclosure permission information sent.

### TECHNICAL FIELD

The present invention relates to a technique for providing and receiving data.

### BACKGROUND ART

In a system for carrying out provision and reception of data between a data owner and a data consumer through an information bank and a personal data store (PDS), a technique for securely carrying out the distribution of data is used.

For example, Patent Literature 1 discloses an information management method and an information management system that better manage confidential information to prevent leakage. Specifically, after association of a user terminal 1 with a mobile terminal 2 via a token TK, the mobile terminal 2 uses public key information regarding a service providing server 3 to encrypt personal information, a personal information managing server 4 records and manages the personal information with the personal information remaining encrypted, and at a point in time when the need for the personal information arises, the service providing server 3 acquires, from the personal information managing server 4, the personal information remaining encrypted and uses a secret key of the service providing server 3 to decrypt the personal information.

### CITATION LIST

### Patent Literature

### Patent Literature 1

Japanese Patent Application Publication, Tokukai, No. 2007-073040

### SUMMARY OF INVENTION

### Technical Problem

In order to entrust the care of data to the personal information managing server 4, a user who is the owner of the data has to carry out various complicated tasks. This is a problem with the technique disclosed in Patent Literature 1. Specifically, the user is required to use two devices which are the user terminal 1 and the mobile terminal 2, and has to carry out an extra operation to associate these devices with each other. It is considered that different data consumers require different pieces of personal information, and also on the user side, the user permits to disclose different pieces of personal information to different consumers. In view of such circumstances, the user needs to encrypt personal information for each data consumer, to entrust the care of the personal information to the personal information managing server 4. Such an operation is considerably burdensome to the user.

In addition, provision and reception of data are not limited to those carried out over a communication network. For example, there is a case where at the request of an enterprise, an individual writes personal information on a form in a predetermined format, and submits the sheet. Thus, there is a wide variety of distribution patterns.

Instead of such various distribution patterns, a technique for easily and securely distributing data is in demand.

An example aspect of the present invention has been made in view of the above problems, and an example object thereof is to provide a technique for easily and securely distributing data.

### Solution to Problem

A data distribution method in accordance with an example aspect of the present invention includes: causing first terminal equipment used by an owner of data to acquire a data item requested by a consumer of data; generating, in a case where the owner has permitted disclosure of data concerning the data item to the consumer, disclosure permission information which means that the owner has permitted disclosure of the data to the consumer and which is unique in a management apparatus managing the data; storing the disclosure permission information in storage capable of being read by the management apparatus, with the disclosure permission information being associated with the data item permitted; outputting, from the first terminal equipment, the disclosure permission information and access information for access to the management apparatus so that second terminal equipment used by the consumer can acquire the disclosure permission information and the access information directly from the first terminal equipment; sending the disclosure permission information from the second terminal equipment to the management apparatus; and returning, from the management apparatus to the second terminal equipment, the data concerning the data item associated with the disclosure permission information sent.

A data distribution method in accordance with an example aspect of the present invention includes: first terminal equipment acquiring a data item requested by a consumer of data, the first terminal equipment being used by an owner of data; at least one processor generating, in a case where the owner has permitted disclosure of data concerning the data item to the consumer, disclosure permission information which means that the owner has permitted disclosure of the data to the consumer and which is unique in a management apparatus managing the data; at least one processor storing, in a case where the owner has permitted disclosure of data concerning the data item to the consumer, the disclosure permission information in storage capable of being read by the management apparatus, with the disclosure permission information being associated with the data item permitted; the first terminal equipment outputting the disclosure permission information and access information for access to the management apparatus so that second terminal equipment used by the consumer can acquire the disclosure permission information and the access information directly from the first terminal equipment; the second terminal equipment sending, to the management apparatus, the disclosure permission information acquired; and the management apparatus returning, to the second terminal equipment, the data concerning the data item associated with the disclosure permission information sent.

First terminal equipment in accordance with an example aspect of the present invention includes: a first acquiring means for acquiring a data item requested by a consumer of data; a sending means for, in a case where the owner has permitted disclosure of data concerning the data item to the consumer, sending disclosure permission information and the data item permitted, to a management apparatus managing the data, the disclosure permission information meaning that the owner has permitted disclosure of the data to the consumer and being unique in the management apparatus; and an outputting means for outputting the disclosure permission information and access information for access to the management apparatus so that second terminal equipment used by the consumer can acquire the disclosure permission information and the access information directly from the first terminal equipment.

Second terminal equipment in accordance with an example aspect of the present invention includes: a second acquiring means for acquiring, directly from first terminal equipment used by an owner of data concerning a data item requested by a consumer, the owner having permitted disclosure of the data, disclosure permission information and access information for access to a management apparatus managing the data, the disclosure permission information meaning that the owner has permitted disclosure of the data to the consumer and being unique in the management apparatus; and a requesting means for sending the disclosure permission information to the management apparatus in accordance with the access information, to request the data from the management apparatus.

A data distribution system in accordance with an example aspect of the present invention includes: a first acquiring means for acquiring, in first terminal equipment used by an owner of data, a data item requested by a consumer of data; a generating means for generating, in a case where the owner has permitted disclosure of data concerning the data item to the consumer, disclosure permission information which means that the owner has permitted disclosure of the data to the consumer and which is unique in the management apparatus managing the data; a managing means for storing, in a case where the owner has permitted disclosure of data concerning the data item to the consumer, the disclosure permission information in storage capable of being read by the management apparatus, with the disclosure permission information being associated with the data item permitted; a second acquiring means for acquiring, in second terminal equipment used by the consumer, the disclosure permission information and access information for access to the management apparatus directly from the first terminal equipment; a requesting means for sending, in the second terminal equipment, the disclosure permission information acquired, to the management apparatus, to request the data from the management apparatus; and a returning means for returning, in the management apparatus, the data concerning the data item associated with the disclosure permission information sent, to the second terminal equipment.

A program in accordance with an example aspect of the present invention is a program for causing a computer to function as first terminal equipment used by an owner of data, the program causing the computer to carry out: a first acquiring process of acquiring a data item requested by a consumer of data; a sending process of, in a case where the owner has permitted disclosure of data concerning the data item to the consumer, sending disclosure permission information and the data item permitted, to a management apparatus managing the data, the disclosure permission information meaning that the owner has permitted disclosure of the data to the consumer and being unique in the management apparatus; and an outputting process of outputting the disclosure permission information and access information for access to the management apparatus so that second terminal equipment used by the consumer can acquire the disclosure permission information and the access information directly from the first terminal equipment.

A program in accordance with an example aspect of the present invention is a program for causing a computer to function as second terminal equipment used by a consumer of data, the program causing the computer to carry out: a second acquiring process of acquiring, directly from first terminal equipment used by an owner of data concerning a data item requested by a consumer, the owner having permitted disclosure of the data, disclosure permission information and access information for access to a management apparatus managing the data, the disclosure permission information meaning that the owner has permitted disclosure of the data to the consumer and being unique in the management apparatus; and a requesting process of sending the disclosure permission information to the managing apparatus in accordance with the access information, to request the data from the management apparatus.

### Advantageous Effects of Invention

With an example aspect of the present invention, it is possible to provide a technique for easily and securely distributing data.

### BRIEF DESCRIPTION OF DRAWINGS

FIG. 1 is a flowchart illustrating a flow of a data distribution method in accordance with a first example embodiment of the present invention.

FIG. 2 is a sequence diagram illustrating a flow of the data distribution method in accordance with the first example embodiment of the present invention, the data distribution method being carried out by a plurality of computers.

FIG. 3 is a block diagram illustrating a configuration of first terminal equipment in accordance with the first example embodiment of the present invention.

FIG. 4 is a block diagram illustrating a configuration of second terminal equipment in accordance with the first example embodiment of the present invention.

FIG. 5 is a block diagram illustrating a configuration of a data distribution system in accordance with the first example embodiment of the present invention.

FIG. 6 is a block diagram illustrating a configuration of a data distribution system in accordance with a second example embodiment of the present invention.

FIG. 7 is a diagram illustrating an example data structure of a database in which data of an owner is stored.

FIG. 8 is a diagram illustrating an example information recording medium having recorded thereon data items requested by a consumer.

FIG. 9 is a diagram illustrating an example input-support screen displayed on a display section of the first terminal equipment.

FIG. 10 is a diagram illustrating an example data structure of a management table for managing disclosure permission information.

FIG. 11 is a diagram illustrating an example output screen displayed on the display section of the first terminal equipment.

FIG. 12 is a diagram illustrating an example acquisition-support screen displayed on a display section of the second terminal equipment.

FIG. 13 is a diagram illustrating an example data presentation screen displayed the display section of the second terminal equipment.

FIG. 14 is a block diagram illustrating an example hardware configuration of the devices in each of the example embodiments of the present invention.

### EXAMPLE EMBODIMENTS

### First Example Embodiment

The following description will discuss a first example embodiment of the present invention in detail, with reference to the drawings. The present example embodiment is basic to the example embodiments that will be described later.

### <Flow of Data Distribution Method>

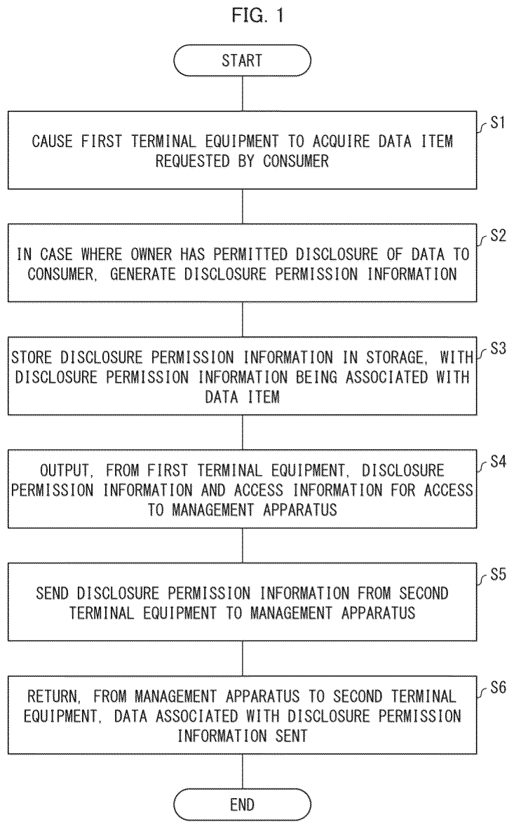

FIG. 1 is a flowchart illustrating a flow of a data distribution method in accordance with the present example embodiment.

In step S1, first terminal equipment used by an owner of data is caused to acquire a data item requested by a consumer of data. As an example, the first terminal equipment may be caused to acquire the above data item from an information recording medium provided by the consumer.

In step S2, in a case where the owner has permitted disclosure of data concerning the data item to the consumer, disclosure permission information is generated, the disclosure permission information meaning that the owner has permitted disclosure of the data to the consumer and being unique in a management apparatus managing data.

In step S3, the disclosure permission information is stored in storage capable of being read by the management apparatus, with the disclosure permission information being associated with the above data item permitted.

In step S4, the disclosure permission information and access information for access to the management apparatus are outputted from the first terminal equipment so that second terminal equipment used by the consumer can acquire the disclosure permission information and the access information directly from the first terminal equipment.

In step S5, the disclosure permission information is sent from the second terminal equipment to the management apparatus.

In step S6, the data concerning the data item associated with the disclosure permission information sent from the second terminal equipment is returned, from the management apparatus to the second terminal equipment.

### <Flow of Data Distribution Method>

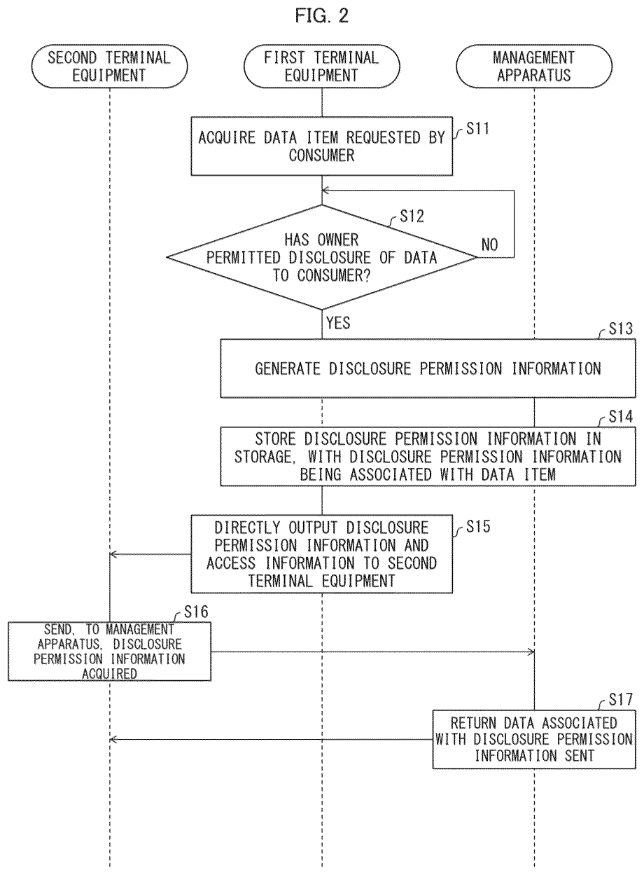

FIG. 2 is a sequence diagram illustrating a flow of the data distribution method in accordance with the present example embodiment, the data distribution method being carried out by a plurality of computers. The plurality of computers includes the first terminal equipment used by the owner of data, the second terminal equipment used by the consumer of data, and the management apparatus managing data.

In step S11, the first terminal equipment acquires a data item requested by a consumer. As an example, the first terminal equipment may acquire the above data item from an information recording medium provided by the consumer.

In step S12, whether the owner has permitted disclosure of data concerning the data item to the consumer is determined. The above determination may be made by, for example, the first terminal equipment. In a case where the owner has permitted disclosure of the data concerning the data item to the consumer, the process proceeds to step S13 through YES of step S12.

In step S13, at least one processor included in at least any one of the plurality of computers generates disclosure permission information, the disclosure permission information meaning that the owner has permitted disclosure of data to the consumer and being unique in the management apparatus managing the data. For example, the generation of the disclosure permission information may be carried out by the first terminal equipment, or may be carried out by the management apparatus.

In step S14, the at least one processor included in any one of the plurality of computers stores the disclosure permission information generated, in storage capable of being read by the management apparatus, with the disclosure permission information being associated with data item permitted. For example, the storage of the disclosure permission information in the storage may be carried out by the first terminal equipment, or may be carried out by the management apparatus.

In step S15, the first terminal equipment outputs the disclosure permission information and access information for access to the management apparatus so that the second terminal equipment can acquire the disclosure permission information and the access information directly from the first terminal equipment. The process of step S15 may be carried out prior to the process of step S14, or changed so as to be carried out concurrently with the process of step S14.

In step S16, the second terminal equipment sends, to the management apparatus, the above disclosure permission information acquired.

In step S17, the management apparatus returns, to the second terminal equipment, data concerning the data item associated with the disclosure permission information sent.

With each of the above methods, it is possible for the owner to use the first terminal equipment having imported therein a data item requested by the consumer of data, to easily carry out the task of permitting disclosure regarding the data item requested by the consumer of data.

The importation of a data item into the first terminal equipment can be carried out with use of means for conveying the data item from the consumer to the owner, without preparing a special apparatus, system, or the like in advance. As an example, the data item may be imported into the first terminal equipment from an information recording medium provided by the consumer. More specifically, the importation may be carried out, for example, without the intervention of a communication network.

Possible methods of the first terminal equipment importing the data item from the information recording medium provided by the consumer are, for example, the following:
(1) Reading an information code which has the data item embedded therein, from a printed medium (information recording medium), such as a piece of paper, which has the information code printed thereon.
(2) Reading the data item from a local memory (information recording medium) of a computer or the like (e.g., second terminal equipment) of the consumer which has the data item stored therein. In this case, the computer of the consumer can send the data item via short-range wireless communication or display the information code on a display section, to cause the data item to be imported into the first terminal equipment of the owner.
(3) Reading the data item from a non-contact IC tag (information recording medium) which has the data item stored therein.
(4) Reading the data item from a removable memory (e.g., USB memory) which has the data item stored therein.

With the above methods, it is possible to easily and accurately import a data item requested by the consumer into the first terminal equipment of the owner, without preparing a special apparatus or system in advance. As a result, it is possible to directly convey, from the consumer to the owner, the data item the disclosure of which is requested by the consumer, without the intervention of a special apparatus or system.

On the basis of the owner having permitted disclosure of the data to the consumer, disclosure permission information unique in the management apparatus is generated. The disclosure permission information is stored in storage capable of being referred to by the management apparatus, with the disclosure permission information being associated with the data item permitted by the owner. This makes it possible for the management apparatus to refer to the storage to determine an owner who has permitted disclosure of data, a consumer to whom the data is disclosed, and the data to be disclosed.

To the second terminal equipment of the consumer, the above disclosure permission information and access information for access to the management apparatus, which are necessary to obtain the data, are provided directly from the first terminal equipment, for example, without the intervention of a communication network. Thus, the disclosure permission information is securely conveyed to the second terminal equipment, without tampering, interception, wrong sending, and any other risks.

The management apparatus can provide the second terminal equipment with only data concerning the data item the disclosure of which has been permitted, on the basis of the disclosure permission information sent from the second terminal equipment, according to the association stored in the storage. Thus, the consumer can use the second terminal equipment which has the disclosure permission information and the access information imported therein, to easily and securely obtain the data.

As described above, it is not necessary for the owner to carry out a burdensome prior setting task such as selecting, for each consumer, a data item the disclosure of which is to be permitted. In addition, it is not necessary for the consumer to establish separate systems between the consumer and the first terminal equipment of the owner and between the consumer and the management apparatus managing data, and carry out prior settings for linkage with such systems. In addition, data of the owner that should be protected is securely provided to the consumer from the management apparatus, only in a case of a data item needed by the consumer, on the basis of the permission granted by the owner. As a result, an example advantage of being capable of easily and securely distributing data is obtained.

### <Variation>

The determination, in step S12, that disclosure has been permitted may be made by the first terminal equipment in response to, for example, the first terminal equipment accepting, from the owner, an input operation indicating that disclosure of the data concerning a data item to the consumer has been permitted.

The generation of disclosure permission information in step S2 or step S13 may be carried out by the first terminal equipment. In this case, in step S2 or step S13, the first terminal equipment generates disclosure permission information in response to the acceptance of the above input operation from the owner. The first terminal equipment then sends, to the management apparatus, the data item acquired in step S1 or step S11 and the disclosure permission information generated.

With the above method, it is possible to prevent the processing load of generating disclosure permission information from being concentrated in the management apparatus. In particular, in a case where the management apparatus needs to manage huge amounts of disclosure permission information and data items for combinations of extremely large numbers of owners and consumers, the merits of the load share are obtained.

The generation of disclosure permission information in step S2 or step S13 may be carried out by the management apparatus. In this case, in step S2 or step S13, the first terminal equipment sends, to the management apparatus, the data item acquired in step S1 or step S11 and information regarding the consumer, in response to the acceptance of the above input operation from the owner. The management apparatus then generates disclosure permission information unique in the management apparatus.

With the above method, it is possible to make simple the configuration of the first terminal equipment. In addition, it is possible to simplify the flow of uniquely managing disclosure permission information in the management apparatus. For example, the management apparatus only needs to generate disclosure permission information such that the disclosure permission information does not overlap previously-generated disclosure permission information. This makes it possible to omit flows such as the flow of checking whether the disclosure permission information generated by each first terminal equipment is unique in the management apparatus and the flow of, in a case of overlap, causing the first terminal equipment to prepare disclosure permission information again.

The storage is intended to be provided in the management apparatus, as an example. Accordingly, storing disclosure permission information in the storage in step S3 or step S14 is carried out by the management apparatus.

In another example, storing disclosure permission information in the storage in step S3 or step S14 may be carried out by, for example, the first terminal equipment. For example, the first terminal equipment stores disclosure permission information and the data item permitted in storage including a cloud server or the like accessible to the management apparatus, with the disclosure permission information being associated with the data item.

In still another example, in step S3 or step S14, the management apparatus may store, in external storage such as a cloud server, disclosure permission information generated by the first terminal equipment or generated by the management apparatus itself and the data item sent from the first terminal equipment, with the disclosure permission information being associated with the data item.

### <Configuration of First Terminal Equipment>

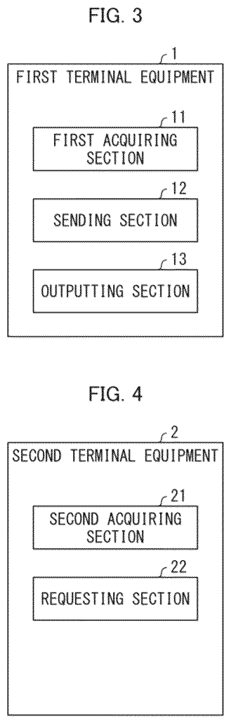

FIG. 3 is a block diagram illustrating a configuration of the first terminal equipment 1 in accordance with the present example embodiment. As is illustrated, the first terminal equipment 1 includes a first acquiring section 11, a sending section 12, and an outputting section 13. In the present example embodiment, the first acquiring section 11 is a component for implementing the first acquiring means. In the present example embodiment, the sending section 12 is a component for implementing the sending means. In the present example embodiment, the outputting section 13 is a component for implementing the outputting means.

The first acquiring section 11 acquires a data item requested by the consumer of data. As an example, the first acquiring section 11 may acquire the data item from information recording medium provided by the consumer.

In a case where the owner has permitted disclosure of data concerning the data item to the consumer, the sending section 12 sends, to the management apparatus, disclosure permission information and the data item permitted, the disclosure permission information meaning that the owner has permitted disclosure of the data to the consumer and being unique in the management apparatus.

The outputting section 13 outputs the disclosure permission information and access information for access to the management apparatus so that the second terminal equipment can acquire the disclosure permission information and the access information directly from the first terminal equipment.

With the above configuration, the first acquiring section 11 acquires the data item requested by the consumer of the data with use of means for conveying a data item from the consumer to the owner, without preparing a special apparatus, system, or the like in advance. For example, the first acquiring section 11 may acquire the data item from information recording medium provided by the consumer. It is therefore possible to easily import the data item the disclosure of which has been requested, into the first terminal equipment without preparing a special apparatus or system in advance. The owner can use the first terminal equipment having the correct data item imported therein, to easily carry out the task of permitting disclosure regarding the data item requested by the consumer of data.

On the basis of the permission having been granted by the owner, the sending section 12 sends, to the management apparatus, disclosure permission information together with the data item permitted by the owner, the disclosure permission information meaning that the owner has been permitted disclosure of the data to the consumer and being unique in the management apparatus. With this sending, the disclosure permission information and the data item are stored in the storage capable of being referred to by the management apparatus, with the disclosure permission information being associated with the data item. This makes it possible for the management apparatus to refer to the storage to determine an owner who has permitted disclosure of data, a consumer to whom the data is disclosed, and the data to be disclosed.

On the basis of the permission having been granted by the owner, the outputting section 13 outputs the disclosure permission information and access information for access to the management apparatus so that the second terminal equipment can acquire the disclosure permission information and the access information directly from the first terminal equipment. This enables the second terminal equipment to acquire, directly from the first terminal equipment, the disclosure permission information and the access information for access to the management apparatus, which are necessary to obtain data. Thus, the disclosure permission information is securely conveyed to the second terminal equipment, without tampering, interception, wrong sending, and any other risks.

By importing the disclosure permission information and the access information, it is possible for the second terminal equipment to acquire, from the management apparatus, data concerning the data item requested by the consumer. It is therefore possible for the consumer to use the second terminal equipment having the disclosure permission information and the access information imported therein, to easily and securely obtain data of the owner.

As a result, an example advantage of being capable of easily and securely distributing data is obtained.

The first terminal equipment 1 may be provided by a computer and a program of the computer. The program is a program for causing the computer to function as the first acquiring section 11, the sending section 12, and the outputting section 13. This program produces the same example advantage that is produced by the above data distribution method and the first terminal equipment 1.

### <Configuration of Second Terminal Equipment>

FIG. 4 is a block diagram illustrating a configuration of the second terminal equipment 2 in accordance with the present example embodiment. As is illustrated, the second terminal equipment 2 includes a second acquiring section 21 and a requesting section 22. In the present example embodiment, the second acquiring section 21 is a component for implementing the second acquiring means. In the present example embodiment, the requesting section 22 is a component for implementing the requesting means.

The second acquiring section 21 acquire, directly from the first terminal equipment 1, disclosure permission information and access information for access to the management apparatus which have been outputted from the first terminal equipment 1. The first terminal equipment 1 is first terminal equipment 1 used by the owner of data the disclosure of which has been permitted, the data concerning the data item requested by the consumer.

The requesting section 22 sends the disclosure permission information to the management apparatus in accordance with the access information, to request data from the management apparatus.

With the above configuration, the second acquiring section 21 acquires, directly from the first terminal equipment 1, disclosure permission information and access information for access to the management apparatus which have been outputted from the first terminal equipment 1 of the owner who has permitted the disclosure of the data. This enables the second terminal equipment to acquire, directly from the first terminal equipment, the disclosure permission information and the access information for access to the management apparatus, which are necessary to obtain data. Thus, the disclosure permission information is securely conveyed to the second terminal equipment, without tampering, interception, wrong sending, and any other risks.

The requesting section 22 can send the disclosure permission information acquired, to the management apparatus in accordance with the access information acquired, and thereby requests data of the owner from the management apparatus. This enables the second terminal equipment to acquire, from the management apparatus, data concerning the data item requested by the consumer. From the above, it is possible for the consumer to use the second terminal equipment having the disclosure permission information and the access information imported therein, to easily and securely obtain data of the owner.

As a result, an example advantage of being capable of easily and securely distributing data is obtained.

The second terminal equipment 2 may be provided by a computer and a program of the computer. The program is a program for causing the computer to function as the second acquiring section 21 and the requesting section 22. This program produces the same example advantage that is produced by the above data distribution method and the second terminal equipment 2.

### <Data Distribution System>

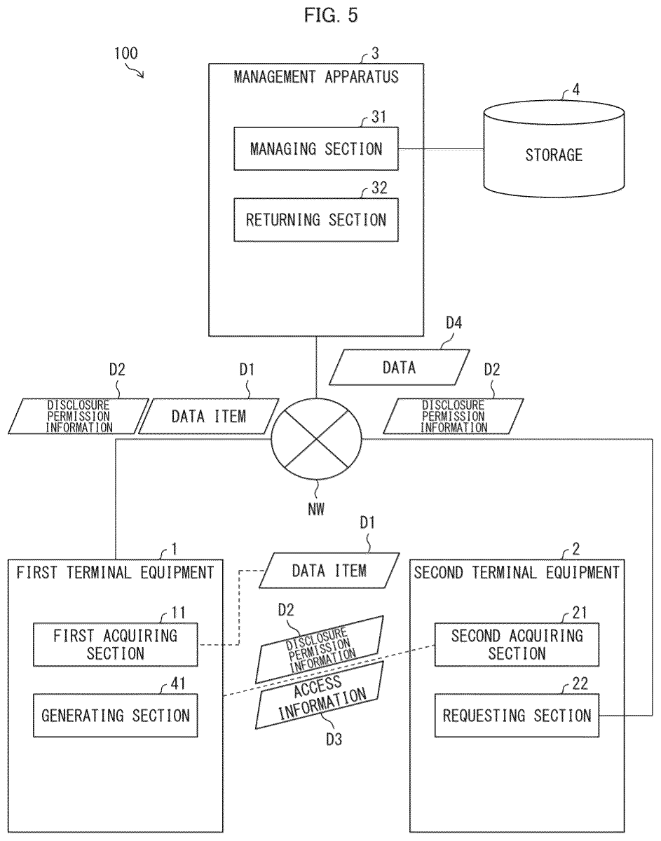

FIG. 5 is a block diagram illustrating a configuration of a data distribution system 100 in accordance with the present example embodiment. As an example, the data distribution system 100 may include the first terminal equipment 1 used by an owner of data, the second terminal equipment 2 used by a consumer of data, and a management apparatus 3 which manages data. The first terminal equipment 1, the second terminal equipment 2, and the management apparatus 3 are connected together so as to be capable of communicating with each other via a communication network NW

As is illustrated, the data distribution system 100 includes a first acquiring section 11, a generating section 41, a managing section 31, a second acquiring section 21, a requesting section 22, and a returning section 32. In the present example embodiment, the first acquiring section 11 is a component for implementing the first acquiring means. In the present example embodiment, the generating section 41 is a component for implementing the generating means. In the present example embodiment, the managing section 31 is a component for implementing the managing means. In the present example embodiment, the second acquiring section 21 is a component for implementing the second acquiring means. In the present example embodiment, the requesting section 22 is a component for implementing the requesting means. In the present example embodiment, the returning section 32 is a component for implementing the returning means.

The first acquiring section 11 acquires a data item D1 requested by the consumer of data, in the first terminal equipment 1 used by the owner of data. For example, the first acquiring section 11 may acquire the data item D1 from information recording medium provided by the consumer.

The information recording medium may be any medium, provided that the medium is capable of holding a data item so that the first terminal equipment 1 can acquire the data item without the need for prior preparation, registration, or the like.

For example, the first acquiring section 11 may acquire the data item from information recording medium provided by the consumer, such as a piece of paper on which an information code having the data item embedded therein is printed.

In another example, the first acquiring section 11 may acquire the data item directly from the second terminal equipment 2 having the data item stored in an information recording medium such as a local memory. Specifically, the first acquiring section 11 may conduct short-range wireless communication such as Bluetooth (registered trademark) communication or infrared communication with the second terminal equipment 2, to acquire the data item sent from the second terminal equipment 2. In another specific example, the first acquiring section 11 may read the data item from an information code or a string of characters displayed on the display section of the second terminal equipment 2.

In still another example, the first acquiring section 11 may acquire the data item by conducting wireless communication with an information recording medium having the data item recorded thereon, such as Felica (registered trademark) or an IC tag.

In still another example, a removable memory such as, for example, a universal serial bus (USB) memory may be leased as the information recording medium, to the owner from the consumer. By connecting, to the first terminal equipment 1, the removable memory having the data item stored therein, the first acquiring section 11 can acquire the data item from the removable memory.

In a case where the owner has permitted disclosure of data concerning the data item to the consumer, the generating section 41 generates disclosure permission information which means that the owner has permitted disclosure of the data to the consumer and which is unique in the management apparatus 3. As an example, in a case where the generating section 41 is provided in the first terminal equipment 1 as is illustrated, disclosure permission information D2 generated by the generating section 41 and the data item D1 acquired by the first acquiring section 11 are sent from the first terminal equipment 1 to the management apparatus 3 via the communication network NW.

In a case where the owner has permitted disclosure of the data concerning the data item to the consumer, the managing section 31 stores the disclosure permission information generated, in storage 4 capable of being read by the management apparatus 3 which manages the data, with the disclosure permission information being associated with the data item permitted.

In the second terminal equipment 2 used by the consumer, the second acquiring section 21 acquires, from the first terminal equipment 1, the disclosure permission information D2 and access information D3 for access to the management apparatus, without the intervention of the communication network NW.

In the second terminal equipment 2, the requesting section 22 sends, to the management apparatus 3, the disclosure permission information D2 acquired by the second acquiring section 21, to request data from the management apparatus 3.

In the management apparatus 3, the returning section 32 returns, to the second terminal equipment 2, data D4 concerning the data item associated with the disclosure permission information sent.

With this configuration, it is possible for the owner to use the first terminal equipment 1 having imported therein the data item D1 requested by the consumer of data, to easily carry out the task of permitting disclosure regarding the data item D1 requested by the consumer of data. It is possible for the first acquiring section 11 to import the data item D1 with use of means for conveying a data item from the consumer to the owner, without preparing a special apparatus, system, or the like in advance. As an example, the first acquiring section 11 may import the data item D1 from an information recording medium provided by the consumer. Thus, the data item D1 the disclosure of which is requested by the consumer is easily and accurately conveyed to the first terminal equipment 1 without the consumer preparing a special apparatus, system, or the like in advance.

On the basis of the owner having permitted the disclosure, the generating section 41 generates disclosure permission information D2 which means that the owner has permitted disclosure of data to the consumer and which is unique in the management apparatus 3. The managing section 31 stores, in the storage 4 to be referred to by the management apparatus 3, the data item D1 acquired by the first acquiring section 11 and the disclosure permission information D2 generated by the generating section 41, with the data item D1 being associated with the disclosure permission information D2. This makes it possible for the management apparatus 3 to refer to the storage 4 to determine an owner who has permitted disclosure of the data D4, a consumer to whom the data D4 is disclosed, and a data item the data D4 concerns.

The second acquiring section 21 provided in the second terminal equipment 2 of the consumer acquires the disclosure permission information D2 and the access information D3 for access to the management apparatus, which are necessary to obtain the data D4, from the first terminal equipment, without the intervention of the communication network NW. Thus, the disclosure permission information D2 is securely conveyed to the second terminal equipment 2, without tampering, interception, wrong sending, and any other risks.

The requesting section 22 sends the disclosure permission information D2 acquired by the second acquiring section 21 to the management apparatus 3 via the communication network NW, to request the data D4 of the owner.

On the basis of the disclosure permission information D2 sent from the second terminal equipment 2, the management apparatus 3 identifies a data item that is stored in the storage 4, the data item being associated with the disclosure permission information D2. This means that the management apparatus 3 is capable of providing the second terminal equipment 2 with only the data concerning a data item the disclosure of which to the consumer has been permitted by the owner. Thus, the consumer can use the second terminal equipment 2 having the disclosure permission information D2 and the access information D3 imported therein, to easily and securely obtain the data D4 of the owner.

As described above, it is not necessary for the owner to carry out a burdensome prior setting task such as selecting, for each consumer, a data item the disclosure of which is to be permitted. In addition, it is not necessary for the consumer to establish separate systems between the consumer and the first terminal equipment 1 of the owner and between the consumer and the management apparatus 3, and carry out prior settings for linkage with such systems.

In addition, the data D4 of the owner that should be protected is securely provided to the consumer from the management apparatus 3, only in a case of a data item needed by the consumer, on the basis of the permission granted by the owner. As a result, an example advantage of being capable of easily and securely distributing data is obtained.

### <Variation>

The generating section 41 may be provided in the management apparatus 3. In this case, the first terminal equipment 1 sends, to the management apparatus 3, the data item D1 acquired by the first acquiring section 11 and information regarding the consumer who is requesting data concerning the data item. The generating section 41 provided in the management apparatus 3 then generates disclosure permission information which means that the owner operating the first terminal equipment 1, which is the sender, has permitted disclosure of the data to the consumer identified by the information regarding the consumer. The generating section 41 generates disclosure permission information so as to be unique in the management apparatus 3. The managing section 31 stores, in the storage 4, the disclosure permission information generated by the generating section 41 and the data item sent from the first terminal equipment 1, with the disclosure permission information being associated with the data item.

The storage 4 may be external storage accessible to the first terminal equipment 1 and the management apparatus 3 via the communication network NW, or may be internal storage included in the management apparatus 3. In a case where the storage 4 is the former, i.e., external storage, the first terminal equipment 1 may store the data item D1 and the disclosure permission information D2 directly in the storage 4, via the communication network NW, with the data item D1 being associated with the disclosure permission information D2.

### Second Example Embodiment

The following description will discuss a second example embodiment of the present invention in detail, with reference to the drawings. A component that has the same function as the component described in the first example embodiment is assigned the same reference sign, and the description thereof is omitted where appropriate.

<Use Case 1: Shopper Provides Retail Shop with Personal Information>

The data distribution system 100 in accordance with the first example embodiment can be applied to the following use case of the present example embodiment. As an example, the use case of the present example embodiment is a case where a shopper provides a retail shop with personal information at the shop.

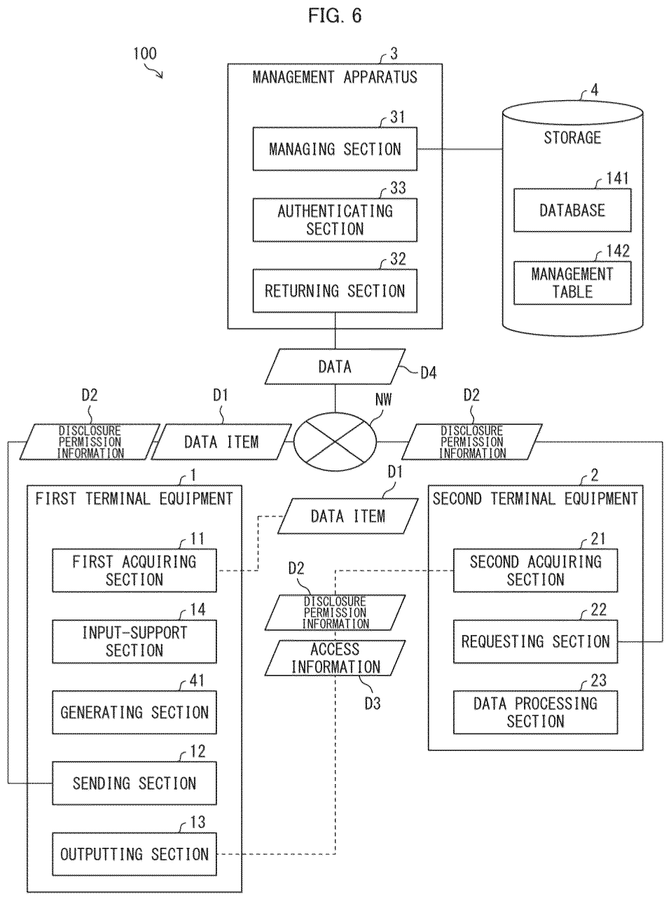

FIG. 6 is a block diagram illustrating a configuration of a data distribution system 100 in accordance with the present example embodiment. In the present example embodiment, data is personal information regarding the shopper, the owner of the data is the shopper, and the consumer of the data is the retail shop. First terminal equipment 1 can be, for example, a smartphone of the shopper. Second terminal equipment 2 is, for example, a point-of-sale (POS) terminal operated by a clerk of the retail shop, and can specifically be a tablet terminal. A management apparatus 3 and storage 4 can be servers or the like operated in an information bank or a personal data store which is entrusted by the shopper with the care of data of the shopper.

The retail shop may have a customer management system (not illustrated) for managing the customers of the retail shop, and the second terminal equipment 2 serving as the POS terminal may have a function of establishing a linkage with the customer management system to forward, to the customer management system, sales results and shopper personal information which are acquired or generated by the second terminal equipment 2.

In the present example embodiment, a database 141 and a management table 142 are stored in storage 4. The data structures of these database and the management table will be described in detail later with reference to other drawings.

In the present example embodiment, the first terminal equipment 1 may further include an input-support section 14. The input-support section 14 supports the owner so that the owner can easily carry out an input task the owner should perform to permit disclosure of data to the consumer. In the present example embodiment, the input-support section 14 is a component for implementing the input-support means.

In the present example embodiment, the management apparatus 3 may further include an authenticating section 33. The authenticating section 33 determines whether the disclosure permission information accepted from the second terminal equipment 2 is valid, and determines whether data of the owner is permitted to be provided to the second terminal equipment 2. In the present example embodiment, the authenticating section 33 is a component for implementing the authenticating means.

In the present example embodiment, the second terminal equipment 2 may include a data processing section 23. The data processing section 23 processes data D4 of the owner, the data D4 being acquired by the requesting section 22 from the management apparatus 3. The data processing section 23 may cause the data D4 to be displayed on a display section of the second terminal equipment 2, to be stored in the storing section of the second terminal equipment 2, and to be forwarded to the customer management system. In the present example embodiment, the data processing section 23 is a component for implementing the data processing means.

### (Data Structure of Database)

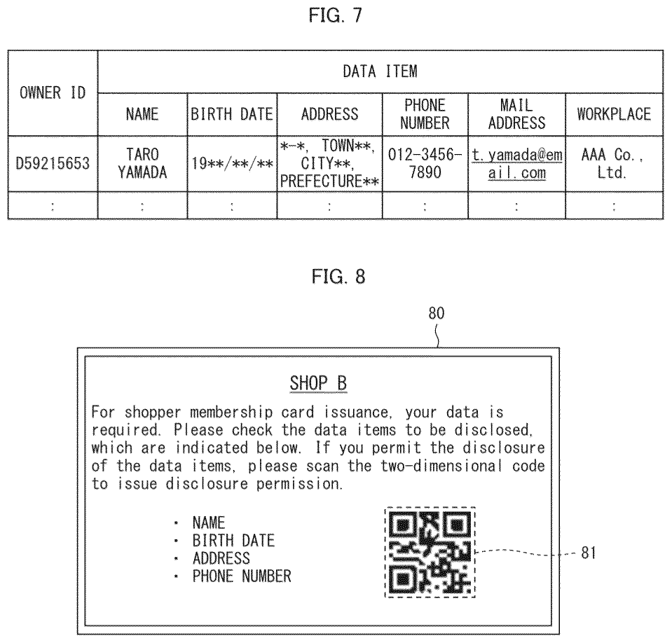

FIG. 7 is a diagram illustrating an example data structure of the database 141 in which data of an owner is stored. The database 141 is stored in the storage 4 and managed by the management apparatus 3. In the database 141, pieces of data the care of which is entrusted by a number of owners are store on a data item by data item basis. As an example, in the present example embodiment, data the care of which is entrusted by an owner may be personal information, and the database 141 may be a personal information database in which an owner-specific personal information is stored. In the example illustrated, the personal information has a structure which includes six data items which are “name”, “birth date”, “address”, “phone number”, “mail address”, and “workplace”. However, the data item is not limited to these. The data item is provided as appropriate according to the purpose of data distribution in the data distribution system 100.

Data concerning each of the data items is stored in the database 141, with the data being associated with an owner ID which is unique to an owner, to clarify the owner of the data.

### (Acquisition of Data Item)

FIG. 8 is a diagram illustrating an example information recording medium having recorded thereon data items requested by a consumer. As an example, an information recording medium 80 may be a printed medium formed by paper or any other material. On the printed medium, an information code 81 capable of being read by the first terminal equipment 1 may be printed. As an example, the information code 81 may be a two-dimensional code such as a QR code (registered trademark) or a bar code. The information code 81 includes at least a data item requested by the consumer from the owner. The data item may not only be embedded in the information code 81 but also be printed on the information recording medium 80 together with the information code 81, as character information so that the owner can understand the content of the data item. Further, for example, the QR code is not limited to a QR code printed on a printed medium such as a piece of paper, but may be a QR code printed or displayed on any medium provided that the QR code is capable of being captured with use of a camera of the first terminal equipment 1. For example, the QR code may be a QR code displayed on a display section of, for example, the second terminal equipment 2. As an example, FIG. 8 illustrates that for a shopper membership card preparation purpose, the retail shop is requesting four data items which are “name”, “birth date”, “address”, and “phone number”.

In addition, on the information recording medium 80, information regarding the consumer requesting data, e.g., the shop name of the retail shop, may be printed as character information. The information regarding the consumer may be embedded in the information code 81.

As an example, the first acquiring section 11 recognizes the information code 81 from the image of the information code 81 captured by a camera or the like and acquires embedded information embedded in the information code 81. As described above, the embedded information at least includes a data item, and may further include information regarding the consumer.

As above, the data item requested by the consumer is presented as the information code 81 capable of being read by the first terminal equipment 1. By using the first terminal equipment 1 that is a smartphone, to carry out an operation of reading the information code 81, the shopper can cause the first terminal equipment 1 to easily and accurately acquire the data item requested by the retail shop. The shopper can then use the first terminal equipment 1 having read the information code 81, to easily carry out the task of permitting disclosure regarding the data item requested by the retail shop.

### (Input-Support for Permission of Disclosure)

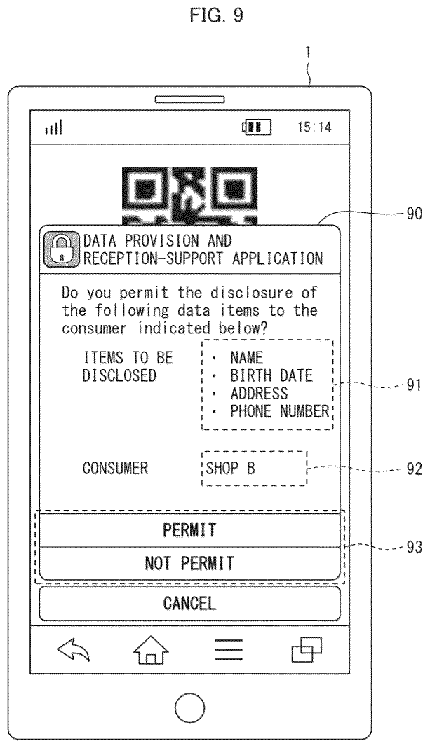

FIG. 9 is a diagram illustrating an example input-support screen displayed on a display section of the first terminal equipment 1. The input-support section 14 generates an input-support screen 90 on the basis of the embedded information acquired by the first acquiring section 11, and displays the input-support screen 90 on the display section.

The input-support section 14 places, in the input-support screen 90, a support user interface (UI) component 93 via which the owner performs an input regarding whether to permit disclosure of at least data concerning the data item requested by the consumer. The input-support section 14 may also place, in the input-support screen 90, data items 91 the disclosure of which is being requested and information 92 regarding the consumer who is requesting the disclosure, so that the owner can confirm such data items and information.

In a case where an input operation performed on a permission button of the support UI component 93 and meaning permission is accepted, the input-support section 14 notifies a generating section 41 of the permission of disclosure of a data item D1 acquired by the first acquiring section 11. In response to this, the generating section 41 generates disclosure permission information for the consumer regarding each of the data items 91.

With the above configuration, when the owner checks the data items indicated on the display section or the information recording medium 80 and then determines that pieces of data concerning these data items may be disclosed to the consumer, the owner only needs to select the permission button of the support UI component 93. In response to the selection of the permission button, the generating section 41 generates the disclosure permission information D2 regarding the data item D1. The disclosure permission information D2 generated and the data item D1 are sent to the management apparatus 3, and as a result, the permission of disclosure of the data item D1 to consumer is conveyed to the management apparatus 3. As above, by simply selecting the permission button, it is possible for the owner to easily convey, to the management apparatus 3, permission of data distribution, without carrying out a complicated setting operation.

### (Generation of Disclosure Permission Information)

In response to the input-support section 14 accepting, from the owner, the input operation indicating permission of disclosure of data to the consumer, the generating section 41 generates disclosure permission information. The disclosure permission information is, for example, information recognized in the data distribution system 100, as evidence that the owner has permitted disclosure of data to the consumer. Specifically, the disclosure permission information may be a token including any string of characters, the string being unique in the management apparatus 3. Further, it is desirable that the generating section 41 set, for the token, at least one selected from the group consisting of an expiration date and the allowed number of uses, as a security measure. For example, the allowed number of uses can be set to “once” for prevention of a second use. That is, a part of the string of characters included in the token may be generated as one-time password.

In the present example embodiment, as an example, the generating section 41 generates a token consisting of a string of characters unique in the management apparatus 3, the expiration date of the token, and the allowed number of uses of the token, which are the disclosure permission information D2.

The sending section 12 sends, to the management apparatus 3, the data item D1 acquired by the first acquiring section 11 and the disclosure permission information D2 generated by the generating section 41, via the communication network NW.

### (Data Structure of Management Table)

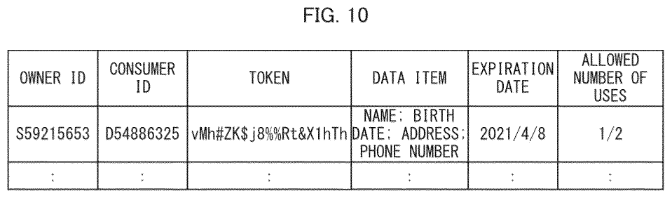

FIG. 10 is a diagram illustrating an example data structure of the management table 142 for managing disclosure permission information. The management table 142 is stored in the storage 4, and is referred to by the management apparatus 3.

The management table 142 is information indicating the correspondence between disclosure permission information and a data item permitted. Thus, by referring to the management table 142, the management apparatus 3 can understand an owner who has permitted disclosure of data, a consumer to which the data is disclosed, and a data item the data concerns.

As an example, the management table 142 has a structure which includes columns of the token and the data items. In a case where the expiration date and the allowed number of uses are set for the token, the management table 142 may have a structure which includes the columns of the expiration date and the allowed number of uses.

The token per se is unique in the management apparatus 3, and does not need to be associated with an owner ID and a consumer ID for management. The column of the consumer ID illustrated may be omitted. Note that information stored in the columns of the owner ID and the consumer ID may be used as reference information for the operator of the management apparatus 3 to understand an owner who has permitted disclosure of data and a consumer to which the data is disclosed.

The owner ID is information for uniquely identifying the owner who has permitted disclosure. The owner ID may be any information provided that the management apparatus 3 can identify the owner. The management apparatus 3 may generate a unique string of characters, which is an owner ID for each owner, to assign the string of characters to that owner. In a case where the owner and the first terminal equipment 1 used by the owner are in one-to-one correspondence, the management apparatus 3 may use identification information regarding the first terminal equipment 1 as the owner ID.

The consumer ID is information for uniquely identifying a consumer to which data of the owner is to be disclosed. The consumer may be an individual, or may be an organization or a group, such as a corporation. The management apparatus 3 may use, as the consumer ID, information regarding the consumer sent from the first terminal equipment 1, such as, for example, a shop name or a company name.

The token is information recognized as evidence that the owner has permitted disclosure of data to the consumer, and includes any string of characters unique in the management apparatus 3.

The data item refers to a data item the disclosure of which to the consumer has been permitted by the owner. The example illustrated indicates that disclosure of four data items which are “name”, “birth date”, “address”, and “phone number” are permitted.

The expiration date refers to an expiration date set for the token. After the expiration date is reached, the relevant token becomes invalid. This means that the management apparatus 3 does not recognize that the owner has permitted disclosure of data concerning a data item to the consumer. The allowed number of uses refers to an allowed number of uses set for the token. For example, the allowed number of uses may be information indicating the upper limit of the number the token is allowed to be used and the number the token has been used so far, or may be information indicating a remaining number the token is allowed to be used. Each time the token is used and the consumer is thus provided with data concerning a data item, the management apparatus 3 increments the “number the token has been used so far”. Alternatively, the management apparatus 3 decrements the “remaining number the token is allowed to be used”. When the allowed number of uses reaches 0, the relevant token becomes invalid.

A managing section 31 of the management apparatus 3 receives the data item D1 and the disclosure permission information D2 from the sending section 12 of the first terminal equipment 1. The disclosure permission information D2 includes the token, the expiration date, and the allowed number of uses. Thus, the managing section 31 can register a record as illustrated in FIG. 10 with the management table 142.

### (Output of Disclosure Permission Information)

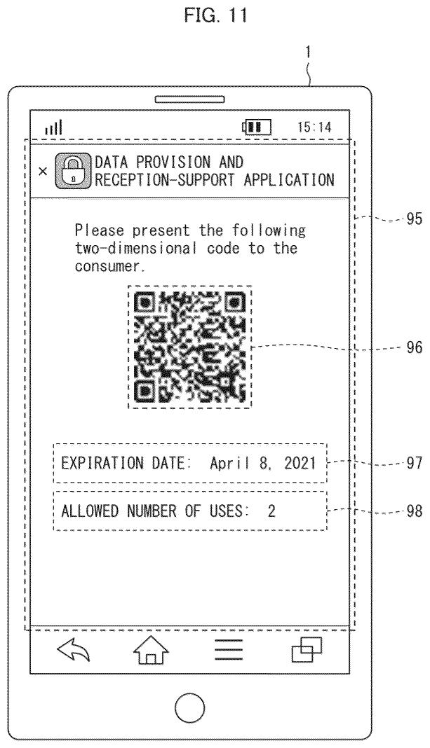

FIG. 11 is a diagram illustrating an example output screen displayed on the display section of the first terminal equipment 1. When an operation of selecting the permission button via the input-support section 14 is accepted and disclosure permission information is generated by the generating section 41, the outputting section 13 generates and displays on the display section an output screen 95. The output screen 95 outputted by the outputting section 13 contains at least the disclosure permission information generated by the generating section 41 and the access information for access to the management apparatus 3. The output screen 95 may further contain an expiration date 97 and the allowed number of uses 98 which are set for the disclosure permission information. Thus, the consumer can understand the expiration date and the allowed number of uses set for the disclosure permission information.

The outputting section 13 outputs the disclosure permission information D2 and the access information D3 so that the second terminal equipment 2 can acquire the disclosure permission information D2 and the access information D3 from the first terminal equipment 1 directly, for example, without the intervention of the communication network. As an example, as is illustrated, the disclosure permission information D2 and the access information D3 may be displayed on the display section of the first terminal equipment 1, as an information code 96 which is capable of being read by the second terminal equipment 2. In the information code 96, the disclosure permission information D2 and the access information D3 are embedded.

The shopper only needs to present the information code 96 displayed on the first terminal equipment 1 to a clerk of the retail shop, to cause the second terminal equipment 2 of the retail shop to read the information code 96. The clerk only needs to carry out an operation of reading the information code 96 with use of the second terminal equipment 2, which is a POS terminal. This makes it possible to cause the second terminal equipment 2 to easily, securely, and reliably acquire access information for access to the management apparatus 3 and disclosure permission information without tampering, interception, wrong sending, and any other risks.

Specifically, the second acquiring section 21 recognizes the information code 96 from an image of the information code 96 captured by a camera of the second terminal equipment 2, to acquire embedded information embedded in the information code 96. As described above, the embedded information contains at least the disclosure permission information and the access information.

### (Data Acquisition Support)

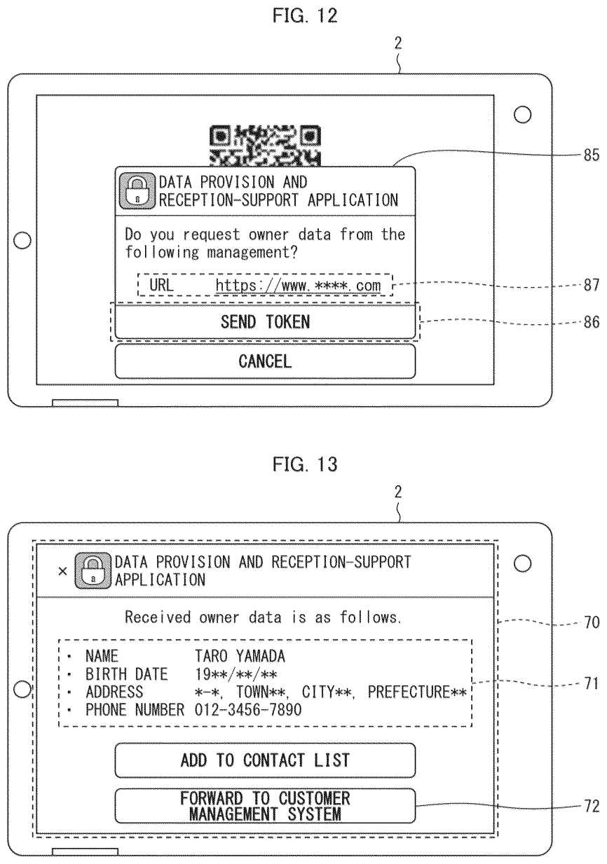

FIG. 12 is a diagram illustrating an example acquisition-support screen displayed on the display section of the second terminal equipment 2. The requesting section 22 generates an acquisition-support screen 85 on the basis of the embedded information acquired by the second acquiring section 21, and displays the acquisition-support screen 85 on the display section. The acquisition-support screen 85 is a screen for supporting an input operation which should be carried out by the consumer (the clerk in the above example) for acquisition of the data of the owner from the management apparatus 3.

The requesting section 22 places, in the acquisition-support screen 85, at least a support UI component 86 via which the consumer carries out an operation of requesting data provision from the management apparatus 3. The requesting section 22 may also place, in the acquisition-support screen 85, access information 87 for access to the management apparatus 3, from which data is acquired, so that the consumer can confirm the access information 87. As an example, the access information 87 may be a uniform resource locator (URL).

The clerk of the retail shop who has checked the acquisition-support screen 85 only needs to select the support UI component 86 for requesting personal information provision from the management apparatus 3, to obtain the personal information regarding the shopper. In response to this selecting operation, the requesting section 22 accesses the access information 87, to send to the management apparatus 3 the disclosure permission information D2 acquired by the second acquiring section 21 and request the personal information regarding the shopper from the management apparatus 3.

### (Authentication and Data Provision)

The authenticating section 33 verifies the disclosure permission information D2 sent from the requesting section 22 against disclosure permission information registered in the management table 142. As an example, the authenticating section 33 searches the management table 142 for a token which matches the token sent from the requesting section 22. In a case where a matching token is stored in the management table 142, the authenticating section 33 checks that the expiration date set for the token has not been reached and the allowed number of uses set for the token is one or greater.

In a case where a token which matches the token sent from the requesting section 22, the expiration date of which has not been reached, and the allowed number of uses of which is one or greater is stored in the management table 142, the authenticating section 33 determines that the disclosure permission information accepted from the second terminal equipment 2 is valid. When the validity of the disclosure permission information is thus checked, the authenticating section 33 determines that data of the owner concerning the data item associated with the disclosure permission information is permitted to be returned to the second terminal equipment 2, from which the disclosure permission information is sent, and so notifies the returning section 32 accordingly.

The returning section 32 reads the data D4 of the owner concerning the data item associated with the disclosure permission information, from the database 141 on the basis of the fact that authentication performed by the authenticating section 33 has succeeded, and returns the data D4 to the second terminal equipment 2, which is the requestor.

### (Data Presentation)

FIG. 13 is a diagram illustrating an example data presentation screen displayed on the display section of the second terminal equipment 2. The data processing section 23 may generate a data presentation screen 70 on the basis of the data D4 acquired by the requesting section 22, and display the data presentation screen 70 on the display section. The data presentation screen 70 is a screen for presenting, to the consumer, data 71 of the owner acquired from the management apparatus 3.

Further, the data processing section 23 may support the consumer in utilizing, according to a predetermined purpose, data of the owner acquired from the management apparatus 3. For example, the data processing section 23 may have the function of forwarding the acquired data 71 of the owner to a customer management system the retail shop operates on its own. In addition, the data processing section 23 may place, in the data presentation screen 70, a support UI component 72 for providing instructions for forwarding.

After checking the data presentation screen 70, the clerk of the retail shop only needs to select the support UI component 72 for providing instructions for forwarding, in order to register the personal information obtained regarding the shopper with the customer management system. In response to this selecting operation, the data processing section 23 forwards the data 71 acquired by the requesting section 22 to the customer management system.

### (Variation: From Data Acquisition Support to Data Presentation)

When reading the information code 96 illustrated in FIG. 11, the second acquiring section 21 conveys, to the requesting section 22, the access information (URL) and the disclosure permission information (token) that have been read. The requesting section 22 may add the token as a parameter to the URL, and launch an application such as, for example, a browser application installed in the second terminal equipment 2, to access the management apparatus 3. The data processing section 23 may display, on the display section through a browser application, a presentation screen received from the management apparatus 3 according to the combination of the URL and the token. Displayed on the presentation screen is data (e.g., name, birth date, address, and phone number) concerning the data items requested by the consumer.

With the above configuration, it is possible for the consumer to easily receive data of the owner without installing a data providing and receiving support application in the second terminal equipment 2 in advance. Specifically, the second terminal equipment 2 is a tablet terminal or a smartphone, in which functions such as, for example, a two-dimensional code reading function and a web browsing function are implemented as standard. The consumer can use the standard functions of the second terminal equipment 2 to easily receive data of the owner.

### Example Advantage

With the data distribution method carried out in the data distribution system 100 in accordance with the present example embodiment, it is possible to more easily and securely distribute data than with conventional data providing and receiving methods. For example, the data distribution method in accordance with the present example embodiment can be used instead of conventional data providing and receiving methods in which a shopper enters personal information by hand and in accordance with this entry, a clerk registers the personal information with a customer management system by manual entry.

Accordingly, the shopper only needs to read, with use of the first terminal equipment 1, a data item presented by the retail shop, and then carry out an easy operation of selecting the support UI component 93, presenting to the clerk the output screen 95 displayed, or the like. This enables the shopper to save the work of entering personal information on a form by hand.

The clerk of the retail shop only needs to read, with use of the second terminal equipment 2, disclosure permission information and access information from the output screen 95, and then carry out an easy operation such as selecting the support UI component 86 and the support UI component 72. Simply by carrying out such a simple operation, it is possible for the clerk to easily obtain data concerning a desired data item regarding the shopper. Further, it is possible to easily forward the obtained data to an existing customer management system of the retail shop, as necessary. Thus, the retail shop can easily and securely obtain the personal information regarding the shopper, without making a cumbersome setting to provide a linkage with the management apparatus 3 in advance. Furthermore, it is possible for the clerk of the retail shop to easily store the obtained personal information in the in-house customer management system simply by providing instructions for forwarding, without registering the personal information with the customer management system by manual entry.

<Use Case 2: Visitor Provides Exhibition Organizer with Business Card Information>

The data distribution system 100 in accordance with each of the example embodiments can be further applied to the following use case. As an example, the use case is a case where a visitor provides an exhibition organizer with business card information.

In the use case, data is business card information regarding the visitor, the owner of the data is the visitor, and the consumer of the data is the exhibition organizer. The first terminal equipment 1 can be, for example, a smartphone of the visitor. The second terminal equipment 2 can be, for example, a two-dimensional code reader installed in the front desk of the exhibition organizer, or a tablet terminal connected to the reader so as to be capable of communicating with the reader. The management apparatus 3 and the storage 4 can be server equipment or the like which manages personnel information of a company to which the visitor belongs.

For example, at the entrance of the venue of the exhibition, a two-dimensional code having embedded therein a data item requested by the exhibition organizer and information regarding the exhibition organizer is presented to the visitor. The two-dimensional code may be presented to a number of visitors with use of digital signage, a signboard, a poster, or the like. Alternatively, a card, a leaflet, a pamphlet, or the like having the two-dimensional code printed thereon may be handed out to an individual visitor.

A data item requested by the exhibition organizer may be business card information that includes, for example, “company name”, “department”, “appointment”, “name”, “company phone number”, mail address”, and the like of the visitor, which are kinds of information included in an analog business card.

When reading the two-dimensional code with use of the first terminal equipment 1 and determining that the business card information is permitted to be disclosed to the exhibition organizer, the visitor selects the permission button of the support UI component 93. The management apparatus 3 serving as the server equipment of the company to which the visitor belongs registers, with the management table 142, the disclosure permission information sent from the first terminal equipment 1 of the visitor, who is an employee of the company, the data item, and the information regarding the exhibition organizer.

The first terminal equipment 1 of the visitor displays, on the display section thereof, the two-dimensional code having embedded therein access information for access to the management apparatus 3 serving as the server equipment of the company and the disclosure permission information. The visitor holds the display section of the first terminal equipment 1 over the reader installed in the entrance of the venue to cause the reader of the exhibition organizer to read the access information for access to the management apparatus 3 and the disclosure permission information.

The second terminal equipment 2 sends, in accordance with the access information acquired by the reader, the disclosure permission information acquired via the reader as well, to the management apparatus 3 of the company of the visitor, to request the business card information regarding the visitor. When authentication succeeds, the management apparatus 3 sends, to the second terminal equipment 2 of the exhibition organizer, business card information concerning the data item associated with the disclosure permission information in the management table 142.

Thus, the business card information regarding the visitor can be easily and securely conveyed to the exhibition organizer without, for example, the visitor signing a visitors' book at the entrance of the venue. With the data distribution method in accordance with the present example embodiment, it is possible to provide saving of work and smoothing of admission handling in the present use case. For the management table 142 managing the personnel information regarding the workplace of the visitor, it is not necessary to set limitations on the expiration date and the allowed number of uses of a token. In this manner, an employee can repeatedly use the function of issuing a token with use of the first terminal equipment 1, as an electronic business card.

In another example, a two-dimensional code having embedded therein disclosure permission information indicating permission of disclosure of the above business card information may be printed on a business card formed of a printed medium such as a piece of paper. The visitor may hand out such a business card to a person (the exhibition organizer in the above case) to whom the business card is permitted to be disclosed. By using the second terminal equipment 2 to read access information and disclosure permission information from a business card having a two-dimensional code printed thereon, it is possible for the exhibition organizer to easily obtain the business card information regarding the visitor.

<Use Case 3: Person Insured Provides Medical Institution with Health Checkup Result>

The data distribution system 100 in accordance with each of the example embodiments can be further applied to the following use case. As an example, the use case is a case where a person insured provides a medical institution with the result of a health checkup.

In the use case, data is the result of a health checkup, the owner of the data is the person insured, and the consumer of the data is the medical institution. The first terminal equipment 1 can be, for example, a smartphone of the person insured. The second terminal equipment 2 can be, for example, a tablet terminal or a personal computer (PC) operated by a healthcare professional (such as doctor, nurse, or care manager) working for the medical institution. The management apparatus 3 and the storage 4 can be server equipment of a health insurance society in which the person insured is enrolled.

Assume, for example, that the person insured has an intention of disclosing the result of a health checkup to a healthcare professional (e.g., regular doctor of the person insured) at a time when the person insured visits a medical institution (community-based small clinic run by a private doctor). The regular doctor uses a tablet terminal which is the second terminal equipment 2 to read a two-dimensional code displayed on the first terminal equipment 1 of the person insured. The second terminal equipment 2 of the regular doctor uses access information embedded in the two-dimensional code having been read, to request the result of a health checkup of the person insured from the management apparatus 3 which is the server equipment of the health insurance society.

The second terminal equipment 2 may acquire, from the management apparatus 3, not only character information but also an image of an x-ray radiograph, as the result of a health checkup of the person insured. The regular doctor can cause the image of the x-ray radiograph and the text of a diagnosis result to be displayed on the second terminal equipment 2, in order to use the image and the text to aid in diagnosis or treatment of the person insured.

With the data distribution system 100, the medical institution does not need to establish a special system in advance for a linkage with the server equipment of the health insurance society. It is possible for a medical institution to easily and securely acquire the result of a health checkup even in a case where there are a plurality of management apparatuses 3, which manage health checkup results, for respective persons insured, or even in a case of the result of a health checkup of a person insured who first visits the medical institution. It is possible for a person insured to easily and securely provide, as necessary, a medical institution with the result of a health checkup of the person insured, even in a case where there are a plurality of medical institutions visited by the person insured, without making various settings for linkages with the respective medical institutions or various settings for permission of disclosure.

### <Variation>

Used in each of the above example embodiments as the technique for acquiring information without the intervention of the communication network NW is a technique of capturing a two-dimensional code such as a QR code (registered trademark) by a camera and recognizing the QR code. However, another technique can be used as the technique for acquiring information without the intervention of the communication network NW. For example, the first terminal equipment 1 may use a short-range wireless communication technique such as Felica (registered trademark), an IC tag, infrared communication, or Bluetooth (registered trademark), to acquire, from the consumer, a data item requested by a consumer and information regarding the consumer, without the intervention of the communication network NW.

The management apparatus 3 may record the history of provision of data of an owner to a consumer. For example, each time the management apparatus 3 accepts, from the second terminal equipment 2 of the consumer, a request of data accompanied by disclosure permission information and returns the data to the second terminal equipment 2, the management apparatus 3 may register, with a history table stored in the storage 4, the data item the data of the owner concerns, the data having been provided. The history table may contain an owner of data provided, a data item provided, the date and time of provision, the number of provisions, etc.

Data items may be managed such that a data item the provision of which is necessary is distinguished from a data item the provision of which is optional. In this case, the information recording medium 80 illustrated in FIG. 8 may have print to indicate whether each of the data items is necessary or optional. Further, the input-support screen 90 illustrated in FIG. 9 may have a representation to indicate whether each of the data items 91 is necessary or optional. In addition, the input-support section 14 may place, in the input-support screen 90, a UI component that enables the optional data items to be individually selected as a data item the disclosure of which is not to be permitted. The owner can carry out an operation of checking the data items 91 of the input-support screen 90 and designating, as not being permitted, only a data item the owner does not wish to disclose, to issue a token. For example, a check box may be provided for each data item, and the owner may be prompted to check or clear only the check box of a data item the owner does not wish to disclose. The generating section 41 stores, in the management table 142, only a data item the disclosure of which is permitted by the owner, with the data item being associated with the token. With the above configuration, it is possible for the owner to separate a data item the disclosure of which is permitted from a data item the disclosure of which is not permitted, by carrying out an easy operation.

### Software Implementation Example

Some or all of the functions of each of the first terminal equipment 1, the second terminal equipment 2, and the management apparatus 3 may be implemented by hardware such as an integrated circuit (IC chip), or may be implemented by software.

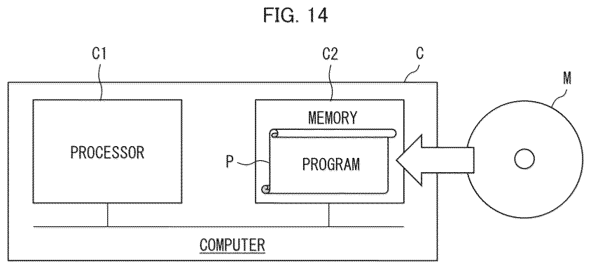

In the latter case, each of the first terminal equipment 1, the second terminal equipment 2, and the management apparatus 3 is provided by, for example, a computer that executes instructions of a program that is software implementing the foregoing functions. An example (hereinafter, computer C) of such a computer is illustrated in FIG. 14. The computer C includes at least one processor C1 and at least one memory C2. The memory C2 has recorded thereon a program P for causing the computer C to operate as at least one selected from the group consisting of the first terminal equipment 1, the second terminal equipment 2, and the management apparatus 3. In the computer C, the processor C1 retrieves the program P from the memory C2 and executes the program P, so that the functions of at least one selected from the group consisting of the first terminal equipment 1, the second terminal equipment 2, and the management apparatus 3 are implemented.

Examples of the processor C1 can encompass a central processing unit (CPU), a graphic processing unit (GPU), a digital signal processor (DSP), a micro processing unit (MPU), a floating point number processing unit (FPU), a physics processing unit (PPU), a microcontroller, and a combination thereof. Examples of the memory C2 can encompass a flash memory, a hard disk drive (HDD), a solid state drive (SSD), and a combination thereof.

The computer C may further include a random access memory (RAM) into which the program P is loaded when executed and in which various kinds of data are temporarily stored. The computer C may further include a communication interface via which data is transmitted to and received from another apparatus. The computer C may further include an input-output interface via which input-output equipment such as a keyboard, a mouse, a display or a printer is connected.

The program P can be recorded on a non-transitory, tangible recording medium M capable of being read by the computer C. Examples of such a recording medium M can encompass a tape, a disk, a card, a semiconductor memory, and a programmable logic circuit. The computer C can obtain the program P via such a recording medium M. Alternatively, the program P can be transmitted via a transmission medium. Examples of such a transmission medium can encompass a communication network and a broadcast wave. The computer C can obtain the program P also via such a transmission medium.

### [Additional Remark 1]

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

### [Additional Remark 2]

The whole or part of the example embodiments disclosed above can be described as, but not limited to, the following supplementary notes.

### (Supplementary Note 1)

A data distribution method including:
causing first terminal equipment used by an owner of data to acquire a data item requested by a consumer of data;
generating, in a case where the owner has permitted disclosure of data concerning the data item to the consumer, disclosure permission information which means that the owner has permitted disclosure of the data to the consumer and which is unique in a management apparatus managing the data;
storing the disclosure permission information in storage capable of being read by the management apparatus, with the disclosure permission information being associated with the data item permitted;
outputting, from the first terminal equipment, the disclosure permission information and access information for access to the management apparatus so that second terminal equipment used by the consumer can acquire the disclosure permission information and the access information directly from the first terminal equipment;
sending the disclosure permission information from the second terminal equipment to the management apparatus; and
returning, from the management apparatus to the second terminal equipment, the data concerning the data item associated with the disclosure permission information sent.

With the above method, an example advantage of being Capable of Easily and Securely Distributing Data is Obtained.

(Supplementary note 2)

A data distribution method including:
first terminal equipment acquiring a data item requested by a consumer of data, the first terminal equipment being used by an owner of data;
at least one processor generating, in a case where the owner has permitted disclosure of data concerning the data item to the consumer, disclosure permission information which means that the owner has permitted disclosure of the data to the consumer and which is unique in a management apparatus managing the data;
at least one processor storing, in a case where the owner has permitted disclosure of data concerning the data item to the consumer, the disclosure permission information in storage capable of being read by the management apparatus, with the disclosure permission information being associated with the data item permitted;
the first terminal equipment outputting the disclosure permission information and access information for access to the management apparatus so that second terminal equipment used by the consumer can acquire the disclosure permission information and the access information directly from the first terminal equipment;
the second terminal equipment sending, to the management apparatus, the disclosure permission information acquired; and the management apparatus returning, to the second terminal equipment, the data concerning the data item associated with the disclosure permission information sent.

With the above method, an example advantage of being capable of easily and securely distributing data is obtained.

(Supplementary note 3)

The data distribution method described in supplementary note 1 or 2, in which the data item requested by the consumer is presented as an information code capable of being read by the first terminal equipment.

With the above method, by using the first terminal equipment to carrying out an operation of reading the information code, it is possible for the owner to cause the first terminal equipment to easily, securely, and reliably acquire a data item requested by the consumer, without tampering, interception, wrong sending, and any other risks.

(Supplementary note 4)

The data distribution method described in supplementary note 3, in which
in the generating,
   in response to acceptance, from the owner, of an input operation indicating that disclosure of the data to the consumer has been permitted, the first terminal equipment is configured to generate the disclosure permission information and send, to the management apparatus, a data item read from the information code and the disclosure permission information.

With the above method, it is possible to prevent the processing load of generating disclosure permission information from being concentrated in the management apparatus. In particular, in a case where the management apparatus needs to manage huge amounts of disclosure permission information and data items for combinations of extremely large numbers of owners and consumers, the merits of the load share are obtained.

(Supplementary note 5)

The data distribution method described in supplementary note 3, in which
in the generating,
   in response to acceptance, from the owner, of an input operation indicating that disclosure of the data to the consumer has been permitted, the first terminal equipment is configured to send, to the management apparatus, a data item read from the information code and information regarding the consumer, and
the management apparatus is configured to generate the disclosure permission information, which is unique in the management apparatus.

With the above method, it is possible to make simple the configuration of the first terminal equipment. In addition, it is possible to simplify the flow of uniquely managing disclosure permission information in the data distribution system.

(Supplementary note 6)

The data distribution method described in any one of supplementary notes 1 to 5, in which the disclosure permission information and access information for access to the management apparatus are displayed as an information code capable of being read by the second terminal equipment, on a display section of the first terminal equipment.

With the above method, the owner only needs to present the information code displayed on the first terminal equipment to the consumer, to cause the second terminal equipment of a retail shop to read the information code. The consumer only needs to carry out an operation of reading the information code with use of the second terminal equipment. This makes it possible to cause the second terminal equipment to easily, securely, and reliably acquire access information for access to the management apparatus and disclosure permission information without tampering, interception, wrong sending, and any other risks.

(Supplementary note 7)

First terminal equipment used by an owner of data, the first terminal equipment including:
a first acquiring means for acquiring a data item requested by a consumer of data;
a sending means for, in a case where the owner has permitted disclosure of data concerning the data item to the consumer, sending disclosure permission information and the data item permitted, to a management apparatus managing the data, the disclosure permission information meaning that the owner has permitted disclosure of the data to the consumer and being unique in the management apparatus; and
an outputting means for outputting the disclosure permission information and access information for access to the management apparatus so that second terminal equipment used by the consumer can acquire the disclosure permission information and the access information directly from the first terminal equipment.

With the above configuration, an example advantage of being capable of easily and securely distributing data is obtained.

(Supplementary note 8)

Second terminal equipment used by a consumer of data, the second terminal equipment including:
a second acquiring means for acquiring, directly from first terminal equipment used by an owner of data concerning a data item requested by a consumer, the owner having permitted disclosure of the data, disclosure permission information and access information for access to a management apparatus managing the data, the disclosure permission information meaning that the owner has permitted disclosure of the data to the consumer and being unique in the management apparatus; and
a requesting means for sending the disclosure permission information to the management apparatus in accordance with the access information, to request the data from the management apparatus.

With the above configuration, an example advantage of being capable of easily and securely distributing data is obtained.

(Supplementary note 9)

A data distribution system including:
a first acquiring means for acquiring, in first terminal equipment used by an owner of data, a data item requested by a consumer of data;
a generating means for generating, in a case where the owner has permitted disclosure of data concerning the data item to the consumer, disclosure permission information which means that the owner has permitted disclosure of the data to the consumer and which is unique in the management apparatus managing the data;
a managing means for storing, in a case where the owner has permitted disclosure of data concerning the data item to the consumer, the disclosure permission information in storage capable of being read by the management apparatus, with the disclosure permission information being associated with the data item permitted;
a second acquiring means for acquiring, in second terminal equipment used by the consumer, the disclosure permission information and access information for access to the management apparatus directly from the first terminal equipment;
a requesting means for sending, in the second terminal equipment, the disclosure permission information acquired, to the management apparatus, to request the data from the management apparatus; and
a returning means for returning, in the management apparatus, the data concerning the data item associated with the disclosure permission information sent, to the second terminal equipment.

With the above configuration, an example advantage of being capable of easily and securely distributing data is obtained.

(Supplementary note 10)

A program for causing a computer to function as first terminal equipment used by an owner of data, the program causing the computer to function as:
a first acquiring means for acquiring a data item requested by a consumer of data;
a sending means for, in a case where the owner has permitted disclosure of data concerning the data item to the consumer, sending disclosure permission information and the data item permitted, to a management apparatus managing the data, the disclosure permission information meaning that the owner has permitted disclosure of the data to the consumer and being unique in the management apparatus; and
an outputting means for outputting the disclosure permission information and access information for access to the management apparatus so that second terminal equipment used by the consumer can acquire the disclosure permission information and the access information directly from the first terminal equipment. This produces an example advantage the same as the example advantage produced by supplementary note 7.
   (Supplementary note 11)

A program for causing a computer to function as second terminal equipment used by a consumer of data, the program causing the computer to function as:
a second acquiring means for acquiring, directly from first terminal equipment used by an owner of data concerning a data item requested by a consumer, the owner having permitted disclosure of the data, disclosure permission information and access information for access to a management apparatus managing the data, the disclosure permission information meaning that the owner has permitted disclosure of the data to the consumer and being unique in the management apparatus; and
a requesting means for sending the disclosure permission information to the managing apparatus in accordance with the access information, to request the data from the management apparatus. This produces an example advantage the same as the example advantage produced by supplementary note 8.
   (Supplementary note 12)

A method for controlling first terminal equipment used by an owner of data, the method including:
the first terminal equipment acquiring a data item requested by a consumer of data;
the first terminal equipment sending, in a case where the owner has permitted disclosure of data concerning the data item to the consumer, disclosure permission information and the data item permitted, to a management apparatus, the disclosure permission information meaning that the owner has permitted disclosure of the data to the consumer and being unique in the management apparatus managing the data; and
the first terminal equipment outputting the disclosure permission information and access information for access to the management apparatus so that second terminal equipment used by the consumer can acquire the disclosure permission information and the access information directly from the first terminal equipment. This produces an example advantage the same as the example advantage produced by supplementary note 7.
   (Supplementary note 13)

A method for controlling second terminal equipment used by a consumer of data, the method including:
the second terminal equipment acquiring, directly from first terminal equipment used by an owner of data concerning a data item requested by a consumer, the owner having permitted disclosure of the data, disclosure permission information and access information for access to a management apparatus managing the data, the disclosure permission information meaning that the owner has permitted disclosure of the data to the consumer and being unique in the management apparatus;
the second terminal equipment sending the disclosure permission information to the managing apparatus in accordance with the access information, to request the data from the management apparatus. This produces an example advantage the same as the example advantage produced by supplementary note 8.
   (Supplementary note 14)

A management apparatus for managing data of an owner, the management apparatus including:
a generating means for generating disclosure permission information unique in the management apparatus, in response to reception, from first terminal equipment used by the owner, of a data item disclosure of which has been permitted by the owner and information regarding a consumer to whom disclosure is to be made;
a managing means for storing, in storage, the disclosure permission information generated and the data item permitted, with the disclosure permission information being associated with the data item; and
a returning means for returning, to second terminal equipment used by the consumer, data of the owner concerning the data item associated with the disclosure permission information in the storage, in response to reception of the disclosure permission information from the second terminal equipment.

With the above configuration, an example advantage of being capable of easily and securely distributing data is obtained.

(Supplementary note 15)

A method for controlling a management apparatus for managing data of an owner, the method including:
the management apparatus generating disclosure permission information unique in the management apparatus, in response to reception, from first terminal equipment used by the owner, of a data item disclosure of which has been permitted by the owner and information regarding a consumer to whom disclosure is to be made;
the management apparatus storing, in storage, the disclosure permission information generated and the data item permitted, with the disclosure permission information being associated with the data item; and
the management apparatus returning, to second terminal equipment used by the consumer, data of the owner concerning the data item associated with the disclosure permission information in the storage, in response to reception of the disclosure permission information from the second terminal equipment. This produces an example advantage the same as the example advantage produced by supplementary note 14.
   (Supplementary note 16)

A program for causing a computer to function as a management apparatus for managing data of an owner, the program causing the computer to function as:
a generating means for generating disclosure permission information unique in the management apparatus, in response to reception, from first terminal equipment used by the owner, of a data item disclosure of which has been permitted by the owner and information regarding a consumer to whom disclosure is to be made;
a managing means for storing, in storage, the disclosure permission information generated and the data item permitted, with the disclosure permission information being associated with the data item; and
a returning means for returning, to second terminal equipment used by the consumer, data of the owner concerning the data item associated with the disclosure permission information in the storage, in response to reception of the disclosure permission information from the second terminal equipment. This produces an example advantage the same as the example advantage produced by supplementary note 14.

### [Additional Remark 3]

The whole or part of the example embodiments disclosed above can further be expressed as follows.

### (Supplementary Note 17)

First terminal equipment used by an owner of data, the first terminal equipment including at least one processor, the at least one processor carrying out:
a first acquiring process of acquiring a data item requested by a consumer of data;
a sending process of, in a case where the owner has permitted disclosure of data concerning the data item to the consumer, sending disclosure permission information and the data item permitted, to a management apparatus managing the data, the disclosure permission information meaning that the owner has permitted disclosure of the data to the consumer and being unique in the management apparatus; and
an outputting process of outputting the disclosure permission information and access information for access to the management apparatus so that second terminal equipment used by the consumer can acquire the disclosure permission information and the access information directly from the first terminal equipment.

The first terminal equipment may further include a memory, and this memory may have stored therein a program for causing the at least one processor to carry out the first acquiring process, the sending process, and the outputting process. In addition, this program may be recorded on a computer-readable, non-transitory, and tangible storage medium.

(Supplementary note 18)

Second terminal equipment used by a consumer of data, the second terminal equipment including at least one processor, the at least one processor carrying out:
a second acquiring process of acquiring, directly from first terminal equipment used by an owner of data concerning a data item requested by a consumer, the owner having permitted disclosure of the data, disclosure permission information and access information for access to a management apparatus managing the data, the disclosure permission information meaning that the owner has permitted disclosure of the data to the consumer and being unique in the management apparatus; and
a requesting process of sending the disclosure permission information to the management apparatus in accordance with the access information, to request the data from the management apparatus.

The second terminal equipment may further include a memory, and this memory may have stored therein a program for causing the at least one processor to carry out the second acquiring process and the requesting process. In addition, this program may be recorded on a computer-readable, non-transitory, and tangible storage medium.

(Supplementary note 19)

A management apparatus for managing data of an owner, the management apparatus including at least one processor, the at least one processor carrying out:
a generating process of generating disclosure permission information unique in the management apparatus, in response to reception, from first terminal equipment used by the owner, of a data item disclosure of which has been permitted by the owner and information regarding a consumer to whom disclosure is to be made;
a managing process of storing, in storage, the disclosure permission information generated and the data item permitted, with the disclosure permission information being associated with the data item; and
a returning process of returning, to second terminal equipment used by the consumer, data of the owner concerning the data item associated with the disclosure permission information in the storage, in response to reception of the disclosure permission information from the second terminal equipment.

The management apparatus may further include a memory, and this memory may have stored therein a program for causing the at least one processor to carry out the generating process, the managing process, and the returning process. In addition, this program may be recorded on a computer-readable, non-transitory, and tangible storage medium.

### REFERENCE SIGNS LIST

1: First terminal equipment
2: Second terminal equipment
3: Management apparatus
4: Storage
11: First acquiring section (first acquiring means)
12: Sending section (sending means)
13: Outputting section (outputting means)
14: Input-support section (input-support means)
21: Second acquiring section (second acquiring means)
22: Requesting section (requesting means)
23: Data processing section (data processing means)
31: Managing section (managing means)
32: Returning section (returning means)
33: Authenticating section (authenticating means)
41: Generating section (generating means)
100: Data distribution system

What is claimed is:

1. (canceled)

2. A data distribution method comprising:
first terminal equipment acquiring a data item requested by a consumer of data, the first terminal equipment being used by an owner of data;
at least one processor generating, in a case where the owner has permitted disclosure of data concerning the data item to the consumer, disclosure permission information which means that the owner has permitted disclosure of the data to the consumer and which is unique in a management apparatus managing the data;
at least one processor storing, in a case where the owner has permitted disclosure of data concerning the data item to the consumer, the disclosure permission information in storage capable of being read by the management apparatus, with the disclosure permission information being associated with the data item permitted;
the first terminal equipment outputting the disclosure permission information and access information for access to the management apparatus so that second terminal equipment used by the consumer can acquire the disclosure permission information and the access information directly from the first terminal equipment;
the second terminal equipment sending, to the management apparatus, the disclosure permission information acquired; and
the management apparatus returning, to the second terminal equipment, the data concerning the data item associated with the disclosure permission information sent.

3. The data distribution method according to claim 2, wherein
the data item requested by the consumer is presented as an information code capable of being read by the first terminal equipment.

4. The data distribution method according to claim 3, wherein
in the generating,
in response to acceptance, from the owner, of an input operation indicating that disclosure of the data to the consumer has been permitted, the first terminal equipment is configured to generate the disclosure permission information and send, to the management apparatus, a data item read from the information code and the disclosure permission information.

5. The data distribution method according to claim 3, wherein
in the generating,
in response to acceptance, from the owner, of an input operation indicating that disclosure of the data to the consumer has been permitted, the first terminal equipment is configured to send, to the management apparatus, a data item read from the information code and information regarding the consumer, and
the management apparatus is configured to generate the disclosure permission information, which is unique in the management apparatus.

6. The data distribution method according to claim 2, wherein
the disclosure permission information and access information for access to the management apparatus are displayed as an information code capable of being read by the second terminal equipment, on a display section of the first terminal equipment.

7. First terminal equipment used by an owner of data, the first terminal equipment comprising at least one processor, the at least one processor carrying out:
a first acquiring process of acquiring a data item requested by a consumer of data;
a sending process of, in a case where the owner has permitted disclosure of data concerning the data item to the consumer, sending disclosure permission information and the data item permitted, to a management apparatus managing the data, the disclosure permission information meaning that the owner has permitted disclosure of the data to the consumer and being unique in the management apparatus; and
an outputting process of outputting the disclosure permission information and access information for access to the management apparatus so that second terminal equipment used by the consumer can acquire the disclosure permission information and the access information directly from the first terminal equipment.

8. Second terminal equipment used by a consumer of data, the second terminal equipment comprising at least one processor, the at least one processor carrying out:
a second acquiring process of acquiring, directly from first terminal equipment used by an owner of data concerning a data item requested by a consumer, the owner having permitted disclosure of the data, disclosure permission information and access information for access to a management apparatus managing the data, the disclosure permission information meaning that the owner has permitted disclosure of the data to the consumer and being unique in the management apparatus; and
a requesting process of sending the disclosure permission information to the management apparatus in accordance with the access information, to request the data from the management apparatus.

9. A data distribution system comprising at least one processor, the at least one processor carrying out:
a first acquiring process of acquiring, in first terminal equipment used by an owner of data, a data item requested by a consumer of data;
a generating process of generating, in a case where the owner has permitted disclosure of data concerning the data item to the consumer, disclosure permission information which means that the owner has permitted disclosure of the data to the consumer and which is unique in the management apparatus managing the data;
a managing process of storing, in a case where the owner has permitted disclosure of data concerning the data item to the consumer, the disclosure permission information in storage capable of being read by the management apparatus, with the disclosure permission information being associated with the data item permitted;
a second acquiring process of acquiring, in second terminal equipment used by the consumer, the disclosure permission information and access information for access to the management apparatus directly from the first terminal equipment;
a requesting process of sending, in the second terminal equipment, the disclosure permission information acquired, to the management apparatus, to request the data from the management apparatus; and
a returning process of returning, in the management apparatus, the data concerning the data item associated with the disclosure permission information sent, to the second terminal equipment.

10. A non-transitory recording medium having stored therein a program for causing a computer to function as first terminal equipment used by an owner of data, the program causing the computer to: carry out:
a first acquiring process of acquiring a data item requested by a consumer of data;
a sending process of, in a case where the owner has permitted disclosure of data concerning the data item to the consumer, sending disclosure permission information and the data item permitted, to a management apparatus managing the data, the disclosure permission information meaning that the owner has permitted disclosure of the data to the consumer and being unique in the management apparatus; and
an outputting process of outputting the disclosure permission information and access information for access to the management apparatus so that second terminal equipment used by the consumer can acquire the disclosure permission information and the access information directly from the first terminal equipment.

11. A non-transitory recording medium having stored therein a program for causing a computer to function as second terminal equipment used by a consumer of data, the program causing the computer to carry out:
a second acquiring process of acquiring, directly from first terminal equipment used by an owner of data concerning a data item requested by a consumer, the owner having permitted disclosure of the data, disclosure permission information and access information for access to a management apparatus managing the data, the disclosure permission information meaning that the owner has permitted disclosure of the data to the consumer and being unique in the management apparatus; and
a requesting process of sending the disclosure permission information to the managing apparatus in accordance with the access information, to request the data from the management apparatus.
